(19) United States
(12) Patent Application Publication
(10) Pub. No.: US 2004/0204188 A1
(43) Pub. Date: Oct. 14, 2004

(54) Grounding system for a cell phone

(76) Inventor: Mark Anthony Stevens, Lake Forest, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/117,152

(22) Filed: Apr. 4, 2002

(51) Int. Cl. H04B 1/38

(52) U.S. Cl. 455/575.1; 455/574; 455/90.3

(57) ABSTRACT

A communication apparatus comprises a transceiver circuit enclosed in a case having a control panel for operation thereof, the case defined by a case thickness and a case length; the case providing a battery bay adapted for receiving a battery, the battery bay and the battery each providing corresponding power terminals positioned for mutual contact with the battery installed within the battery bay; the power terminals including at least one RF circuit ground terminal establishing a ground voltage level for transmission and receive signals of the apparatus; an electrical conductor engaged with an outer surface of the case, the conductor terminating at the at least one RF circuit ground terminal.

### BACKGROUND OF THE INVENTION

1. Field of the Invention

This invention relates generally to grounding systems and methods for electrical devices and more particularly to an improved grounding system for use particularly with a wireless communication device that is hand held.

2. Description of Related Art

The following art defines the present state of this field:

Hoynes, U.S. Pat. No. 3,329,957 describes an antenna system for use with a radio communication instrument comprising: means for coupling the body of a user of said communication instrument and ground to said communication instrument with the user's body as a vertical radiator of the antenna system operating against ground, said coupling means comprising capacitive means mounted in the user's footwear.

Ikrath et al., U.S. Pat. No. 3,902,118 describes A body-coupled portable radio transmitter to be worn camouflaged, at about waist level, in the manner of a shoulder bag, under a covering outer garment, and depending from a resilient flexible open coil for coupling RIF output of the transmitter to the body to be radiated by the body, the coil diameter being small enough for the coil to be worn under the garment and there being a sufficient number of turns in the coil to be tunable in place on the wearer, the combination with the transmitter being operable at average output power on the order of 1 watt, which is low enough not to be hazardous to the health of the wearer while having good signal-to-noise ratio, in a frequency band high enough for good radiation efficiency, i.e. above 3 MHz, but not so high as to introduce health hazards to the wearer, i.e. below 40 MHz, and operable with radiation efficiency greater than that of the same transmitter equipped with a whip antenna operated at the same average power and frequency when positioned next to the same person where the whip antenna does not extend shove the head of the wearer so as not to be visible.

Pando, U.S. Pat. No. 3,983,483 describes a communications device arranged to be worn in intimate contact with the body of a user and without interference with bodily movements including a radio transmitter and receiver for communicating with a remote station. The transmitter includes means arranged therewith and operative in conjunction with the body of the user for providing a relatively high transmitting frequency range. The device is miniaturized so as to provide predetermined transmitting and receiving circuit characteristics and is encapsulated so as to be essentially floatable, resilient and waterproof whereby it is rendered suitable outdoor activities such as sports and the like.

Rogers et al., U.S. Pat. No. 4,876,709 describes an antenna internally contained within a housing of a cordless telephone that is configured generally as a plate disposed opposite the earphone transducer, and away from the user's face in position for normal use. The antenna is disposed to lie generally vertically, and is counterpoised against a generally vertically disposed circuit board. Configuring the antenna generally as a plate and placing it outboard away from the user's face minimizes detuning effects during normal handling in use. Optional side extensions to the plate increase the antenna capacitance. An optional counterpoising shield may be interposed between the receiver-transducer and the antenna plate to further minimize detuning effects. Mode switches are disposed in a position on the handset remote from the antenna to further minimize detuning effects during switching operations. A similar antenna may be disposed within the cordless telephone base unit with the antenna disposed remote from the surface on which the base unit is mounted, and further having its associated mode switch disposed at a location remote from the antenna so as to minimize detuning effects from proximity to metallic surfaces and mode switching.

Sudo, U.S. Pat. No. 5,138,651 describes a cordless loud-speaking telephone that is shaped to be placed on a table or desk or to be suspended from a ceiling. Unlike cordless portable telephones of the handy transceiver type, it enables hands-free talking or communication through a receiving speaker and a transmitting microphone located outside a casing. An antenna conductor and counterpoises are projected from the casing, and a microphone is attached to the counterpoises or the antenna conductor such that the microphone is separated as remotely as possible from the speaker in the casing. As a result, howling and echo which disturb talking or communication via the telephone can be suppressed. Further, plural microphones are attached to plural antenna conductors or counterpoises to cancel the sound of the receiving speaker to prevent the voice from again entering the microphones, or the microphones are attached to the counterpoises or the antenna conductors in such a manner that they effectively receive the voice from the mouth of a talking person from a certain direction. This enables hands-free talking or communication to be more effectively and reliably achieved.

Gomez, U.S. Pat. No. 5,835,064 describes an adapter assembly for adapting a portable cellular telephone to receive an external replacement antenna or an external direct feed connection by replacing the internal antenna connection of the cellular telephone. The adapter assembly includes a body portion with an antenna-receiving bore, a telephone chassis contact portion at the other end a circuit board interposed between the body and contact portion which spaces them apart and interconnects them together. The circuit board has circuitry thereon which transposes the connections effected thereby between coaxial conductors of the assembly body and contact portions.

Sakata, U.S. Pat. No. 6,061,028 describes a flat antenna unit for a mobile communication equipment which is pasted on the mobile communication equipment so that it is touched by a human hand when in use, comprising a flexible insulated base; a receiving circuit which is formed on the flexible insulated base and which comprises three conductive layers of a pair of U-shaped conductive layers which are isolated and symmetrically disposed each other, a pair of conductive layers which have bent sections at the ends thereof and which are isolated and symmetrically disposed on the both sides of the U-shaped conductive layers, and a conductive layer which is isolated from the above-mentioned conductive layers as well as from the U-shaped conductive layers and which is located above the U-shaped conductive layer; and an insulator which is formed by potting insulating ink for example and which is coated on the receiving circuit. The flat antenna unit is characterized in that when the insulator is touched by the hand, a tuning capacitor is formed between the hand and the receiving circuit via the insulator. Thereby, the inventive antenna unit can eliminate troubles during speech like noise and interruption even when the radio efficiency is bad in using the mobile communication equipment such as a portable phone at places where the strength of electric field is weak.

Edvardsson, U.S. Pat. No. 6,204,817 describes a portable radio communication device, comprising: a housing; antenna means for transmitting and receiving RF signals; transmitting and receiving circuits arranged in the housing; at least a conductive portion; antenna feeding means; and, a user interface. The antenna means includes a transmitting antenna, and a receiving antenna. The transmitting antenna, and the receiving antenna have orthogonal radiating characteristics in relation to each other. The transmitting and the receiving antennas can be of an electric dipole type or a magnetic dipole type. An antenna system including a transmitting and a receiving antenna is also disclosed.

Sakata, WO98/24142 describes a plane antenna system which is stuck to mobile communication equipment so that the system can be used in a state where the system is touched by the hand of a man is constituted by forming a receiving circuit having three kinds of conductive layers composed of a pair of U-shaped conductive layers which are arranged at an interval and have symmetrical shapes, a pair of conductive layers which are arranged at distances from and on both sides of the layers and have symmetrical shapes and bent sections at their ends, and a conductive layer which is positioned above the conductive layers at distance from the layers on a flexible insulating substrate and coating the circuit with an insulator which is formed by the potting, etc., of insulating ink so that, when a man puts his hand on the insulator, a tuning capacitor can be formed among the hand, the insulator, and the circuit. Since the tuning capacitor is formed among the hand of a man, the insulator, and the circuit when the man puts the hand on the insulator, noise can be reduced during speech and, even when the efficiency of radio waves is bad at the time of using the equipment in an electric field having a low intensity, such troubles that the speech is interrupted by noise, speech is discontinued, and so on, can be eliminated. In addition, the antenna system can be constituted in a small-sized, light, and thin flexible body so that the system can be stuck to the rear surface, etc., of a portable telephone set.

The prior art teaches the use of portable communication systems such as cell phones and of improvements to the signal to noise ratio in such communications by contact with the body of a person using the system, but the prior art fails to teach a system for improved signal strength through improved grounding by body contact. The present invention fulfills these needs and provides further related advantages as described in the following summary.

### SUMMARY OF THE INVENTION

The present invention teaches certain benefits in construction and use which give rise to the objectives described below.

A communication apparatus comprises a transceiver circuit enclosed in a case having a control panel for operation thereof, the case defined by a case thickness and a case length; the case providing a battery bay adapted for receiving a battery, the battery bay and the battery each providing corresponding power terminals positioned for mutual contact with the battery installed within the battery bay; the power terminals including at least one RF circuit ground terminal establishing a ground voltage level for transmission and receive signals of the apparatus; an electrical conductor engaged with an outer surface of the case, the conductor terminating at the at least one RF circuit ground terminal. The electrical conductor may be mounted on the cell phone at the factory where it is built into the case surface and joined with the RF ground within the case rather than at a battery terminal, or it may be adhered to the outer surface of the case and joined to the RF ground terminal of the battery terminal.

A primary objective of the present invention is to provide an apparatus and method of use of such apparatus that provides advantages not taught by the prior art.

Another objective is to provide such an invention capable of improved grounding of an RF signal in a cell phone.

A further objective is to provide such an invention capable of being mounted on a case of a cell phone and interconnected with a ground terminal.

A still further objective is to provide such an invention capable of being contacted by a hand or by an ear of a cell phone user.

A still further objective is to provide such an invention capable of boosting radio signals for improved reception and transmission.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of the preferred embodiment of the invention showing a front panel thereof;

FIG. 2 is a perspective view showing a rear panel thereof;

FIG. 3 is a schematic diagram thereof wherein a metal strip of the invention is mounted on the case of a cell phone; and

FIG. 4 is a schematic diagram thereof wherein a metal strip of the invention is mounted on battery case of a cell phone.

### DETAILED DESCRIPTION OF THE INVENTION

The above described drawing figures illustrate the invention in at least one of its preferred embodiments, which is further defined in detail in the following description.

The invention is a communication apparatus comprising a transceiver circuit 10 enclosed in a case 20 having a control panel 30 for operation. The case 20 is defined by a case thickness 40 and a case length 50. The case 20 provides a battery bay 60 adapted for receiving a battery 70, the battery bay 60 and the battery 70 each providing corresponding power terminals 80 positioned for mutual contact when the battery 70 is installed within the battery bay 60. The power terminals 80 include at least one RF circuit ground terminal 82 which establishes a ground voltage level for transmission and receive signals of the apparatus. An electrical conductor 90 is engaged with an outer surface 22 of the case 20, and terminates at the at least one RF circuit ground terminal 82. Preferably, the conductor 90 is not wider than the case thickness 40 and is of a length approximating the case length 50. It has been found that when the conductor 90 is larger than the foregoing, it tends to restrict or otherwise affect transmission. When the conductor 90 is appreciably smaller is tends to not make good skin contact depending on how the device is being held.

Preferably, the electrical conductor 90 provides an outer conductor surface 92, the conductor surface positioned above the case outer surface 22 so that the skin of the operator is assured of making good contact with the conductor 90.

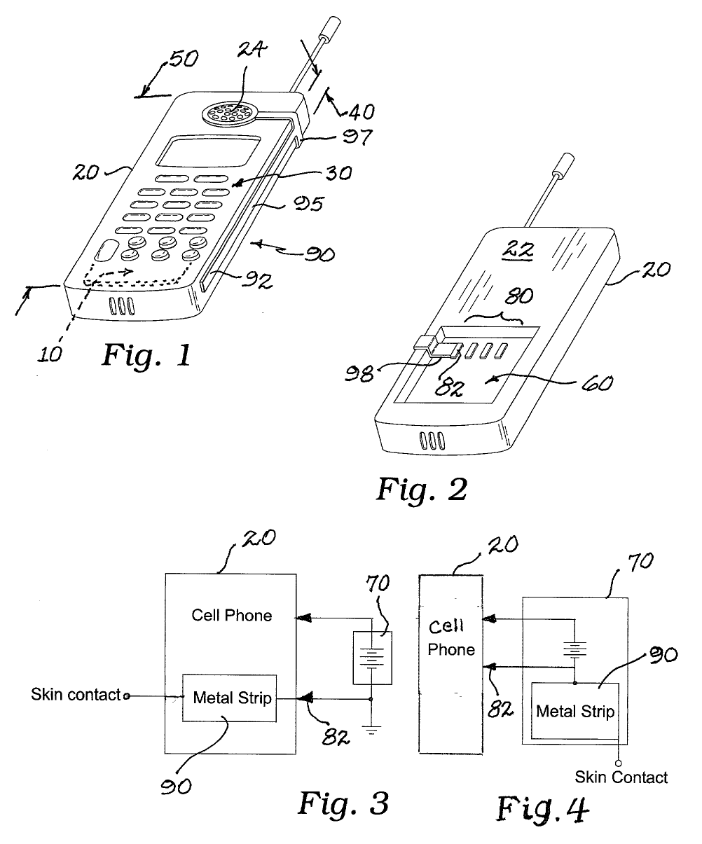

In one preferred embodiment, the conductor 90 is positioned around a speaker aperture 24 in the case outer surface 22 as shown in FIG. 1.

In another preferred embodiment, the conductor 90 is positioned around the speaker aperture and also along one or more sides of the case outer surface as is shown in FIG. 1.

In an alternate embodiment, the conductor is not attached at a battery terminal but through any other common engagement to the RF circuit ground plane in the invention, as would be within the skill of the average electrical engineer or packaging design engineer.

In a further alternate embodiment, the electrical conductor 90 has a first 95 and a second 97 legs formed in a common plane, the first 95 of the legs having a length approximating the length of a cell phone as previously described, the second 97 of the legs positioned at a right angle to the first 95 of the legs and of a length necessary for the second 97 of the legs to extend from the first 95 of the legs to the RF circuit ground terminal 82 in the battery bay 60 of the cell phone or other device, the conductor 90 providing an adhesive 98 on a contact side thereof for engaging the outer surface 22 of the case 20 of the cell phone for mounting the electrical conductor 90 on the case 20 of the cell phone. In this embodiment, the conductor 90 is installed by the cell phone user to accomplish the same result as described above.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A communication apparatus comprising: a transceiver circuit enclosed in a case of electrically insulating material, the case having a control panel for operation thereof, the case defined by a case thickness and a case length; the case providing a battery bay adapted for receiving a battery, the battery bay and the battery each providing corresponding power terminals positioned for mutual contact with the battery installed within the battery bay; the power terminals including at least one RF circuit ground terminal establishing a ground voltage level for transmission and receive signals of the apparatus; an electrical conductor engaged with an outer surface of the case, the conductor terminating at the at least one RF circuit ground terminal.

2. The apparatus of claim 1 wherein the conductor is not wider than said case thickness and is of a length approximating said case length.

3. The apparatus of claim 2 wherein the electrical conductor provides an outer conductor surface, the conductor surface positioned above a case outer surface.

4. The apparatus of claim 1 wherein the conductor is positioned around a speaker aperture in a case outer surface.

5. The apparatus of claim 1 wherein the conductor is positioned around a speaker aperture and along one side in a case outer surface.

6. The apparatus of claim 1 wherein the conductor is positioned on a battery of the case.

7. A communication apparatus comprising: a transceiver circuit enclosed in a case of electrically insulating material, the case having a control panel for operation thereof, the case defined by a case thickness and a case length; the case providing a battery bay adapted for receiving a battery, the battery bay and the battery each providing corresponding power terminals positioned for mutual contact with the battery installed within the battery bay; the power terminals including at least one RF circuit ground terminal establishing a ground voltage level for transmission and receive signals of the apparatus; an electrical conductor engaged with an outer surface of the case, the conductor electrically common with the at least one RF circuit ground terminal.

8. The apparatus of claim 7 wherein the conductor is not wider than said case thickness and is of a length approximating said case length.

9. The apparatus of claim 8 wherein the electrical conductor provides an outer conductor surface, the conductor surface positioned above a case outer surface.

10. The apparatus of claim 7 wherein the conductor is positioned around a speaker aperture in a case outer surface.

11. The apparatus of claim 7 wherein the conductor is positioned around a speaker aperture and along one side in a case outer surface.

12. A communication apparatus comprising: an electrical conductor having a first and a second legs formed in a common plane, the first of the legs having a length approximating the length of a cell phone, the second of the legs positioned at a right angle to the first of the legs and of a length necessary for the second of the legs to extend from the first of the legs to an RF circuit ground terminal in a battery bay of the cell phone, the conductor providing an adhesive on one side thereof for engaging an outer surface of a case of the cell phone for mounting the electrical conductor on the case of the cell phone.

13. The apparatus of claim 12 wherein the first of the legs of the electrical conductor is not wider than a thickness of a cell phone case, and is of a length approximating the length of a cell phone case.

14. The apparatus of claim 12 wherein the conductor further provides a portion adapted for positioning around a speaker aperture in a cell phone case outer surface.

15. The apparatus of claim 12 wherein the conductor is positioned on a battery of the case.
